(19) United States
(12) Patent Application Publication
(10) Pub. No.: US 2026/0006428 A1
(43) Pub. Date: Jan. 1, 2026

(54) NETWORK IDENTIFIER TRANSLATION AND DATA REPOSITORY DISCOVERY

(71) Applicant: HEWLETT PACKARD ENTERPRISE DEVELOPMENT LP, Spring, TX (US)

(72) Inventors: Ravi Saxena, Bangalore (IN); David Schild, Houston, TX (US); Lu Tian, Frisco, TX (US); Mousumi Bhattacharya, Bangalore (IN)

(21) Appl. No.: 18/819,104

(22) Filed: Aug. 29, 2024

(30) Foreign Application Priority Data
Jun. 27, 2024 (IN) 202411049468

(51) Int. Cl. H04W 8/18; H04W 48/16

(52) U.S. Cl. CPC H04W 8/18; H04W 48/16

(57) ABSTRACT

Systems and methods are provided for identifying a first Unified Data Repository (UDR) instance storing a first user equipment identifier (UEID) type value, which may be a Generic Public Subscription Identifier (GPSI) value. The first UEID type value is translated to a second UEID type value, which may be a Subscription Permanent Identifier (SUPI) value. A second UDR instance storing a range of second UEID type values within which the identified second UEID type value is included is identified, and a service request specifying the first UEID type value (received, e.g., from a network function (NF)) can be forward to the identified second UDR instance to satisfy the service request.

### BACKGROUND

Wireless or mobile devices (e.g., smart phones, tablets, and laptops) are used to send and receive data. Such data may be transmitted and received over a wireless/mobile network. 5G is a standard promulgated by the International Telecommunication Union (ITU) and the 3rd Generation Partnership Project (3GPP), with the ITU setting the minimum requirements for 5G compliance, and the 3GPP creating the corresponding specifications. 5G is a successor to the 4G/Long Term Evolution (LTE) standard, and refers to the fifth generation of wireless broadband technology for digital cellular networks. 5G is intended to replace or augment 4G/LTE. Touted advantages of 5G include, e.g., exponentially faster data download and upload speeds, along with much-reduced latency (also referred to as “air latency,” i.e., the time it takes for a device to communicate with the network). Another advantage of 5G is the introduction of network slicing, which can refer to the ability to create/operate multiple virtual networks, each designed/dedicated to a specific use case, for example.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 illustrates an example data storage architecture within which examples of the disclosed technology may be implemented.

FIG. 2 illustrates example interactions between a unified data management (UDM) function and other network functions where network identifier translation and user data repository (UDR) instance discovery in accordance with examples of the disclosed technology may be used.

FIG. 3 illustrates example operations performed to effectuate network identifier translation and UDR instance discovery in accordance with examples of the disclosed technology.

FIG. 4A is an example computing component that may execute instructions to achieve UDM functionality to translate network identifiers and identify a UDR instance in accordance with examples of the disclosed technology.

FIG. 4B is an example computing component that may execute instructions to achieve UDM functionality to identify a UDR instance in accordance with examples of the disclosed technology.

FIG. 5 is an example computing component that may execute instructions to achieve UDR functionality to respond to and satisfy a service request based on a translated network identifier in accordance with examples of the disclosed technology.

FIG. 6 is an example computing component that may be used to implement various features of examples of the disclosed technology.

The figures are not exhaustive and do not limit the present disclosure to the precise form disclosed.

### DETAILED DESCRIPTION

In 5G communications, various network identifiers may be used, e.g., permanent or temporary subscriber identities may be generated to identify particular subscribers or user equipment (UE) as well as network functions (NFs) where such subscriber records are stored. For example, each subscriber in a 5G network or system may be assigned a 5G subscription permanent identifier (SUPI) for use in the 3GPP 5G system. An International Mobile Subscriber Identifier (IMSI) or a Network Access Identifier (NAI) are examples of SUPIs. A Generic Public Subscription Identifier (GPSI) can be used to address 3GPP subscriptions outside of a 3GPP system/network. Examples of a GPSI are public identifiers such as a Mobile Station International Subscriber Directory Number (MSISDN) or an external ID.

Unified Data Management (UDM) refers to a particular network function (NF) or service related to the 5G Core network for managing user data/subscriber data. UDM acts as a front-end service for storing/retrieving subscription data for users in/from a User Data Repository (UDR). UDR can refer to a repository for subscription data, which can store the subscription data as customer profile information, customer authentication information, and encryption keys. That is, queries or requests can be made by some network function, such as a network data analytics function or a session management function, which may prompt the UDM to access the UDR to retrieve subscription data satisfying the query or request. Some queries or requests may specify a SUPI, while others may specify a GPSI. The UDM, regardless of the type of identifier received, should be able to retrieve/access the proper subscription data/resources. Typically, the UDR will store an association between a GPSI value and a SUPI value. Nevertheless, problems arise in certain scenarios depending on the type of network identifier specified or included in a query or request.

To the above, large networks, such as those operated by Tier-1 operators, have such voluminous subscription records, it is nearly impossible to maintain all subscribers of an operator in a single UDR instance. For example, an operator may have regionally-partitioned UDR instances such that subscription data associated with subscribers can be split between, e.g., a West Coast UDR instance, a Midwest UDR instance, and an East Coast UDR instance. Each UDR instance may register its UDR Profile (that includes some range of user identifiers) of a given identifier type (SUPI or GPSI) with the Network Repository Function (NRF), a 5G Core network NF that acts as a services discovery broker for NFs in the 5G Core. It is impractical for a single UDR instance to register its profile to include multiple identifier types. It should be noted that while ranges of SUPI values can be partitioned amongst multiple UDR instances, ranges of GPSI values cannot be split (or it is impractical to do so).

Typically, a first UDR instance, referred to as a lookup UDR, may comprise a UDR instance registered based on a GPSI values range, which includes only identity-data resources, and a second one or more UDR instances may comprise a set of partitioned UDR instances registered in accordance with various SUPI value ranges. When a SUPI value is received, UDM will know to access one of the partitioned UDR instances associated with SUPIs. However, if a service or NF request only contains a GPSI value, UDM will always discover the lookup UDR instance, and send the request to that lookup UDR instance. Because the lookup UDR instance only maintains identity-data resources, other subscriber resources cannot be identified, and an error will be returned in response to the request. Even if the GPSI can be mapped to the proper SUPI, the UDM will return that SUPI, but the request will still only be routed to the lookup UDR instance (the GPSI/lookup UDR), again creating a problem with respect to identifying/retrieving the proper subscriber resources. While certain GPSI-SUPI mapping solutions exist, associating various identifiers with a proper UDR instance requires logic that creates undesirable latencies/negatively impacts the user experience.

Accordingly, examples of the disclosed technology comprise UDM functionality that, upon receiving a request with a GPSI, discovers a first, GPSI-registered UDR instance (a UDR instance whose registered profile indicates storage of GPSI values). The UDM may determine a SUPI value that corresponds to the GPSI received in the request. In some examples, the UDM may leverage an “IdentityData” resource operation specified in the 5G standard to map the GPSI value to a corresponding SUPI value. The UDM, upon discovering the SUPI value corresponding to the received GPSI value, may perform another discovery operation based on the SUPI value to determine the proper UDR instance of the plurality of SUPI-registered and partitioned UDR instances. The UDM may then forward the received service request to the proper SUPI-registered and partitioned UDR instance. In this way, not only can a GPSI value be mapped to a SUPI value, but the UDR instance associated with the SUPI value (the SUPI value falls within the particular SUPI value range partition), can be discovered/identified, and requisite standard subscriber resources can be accessed/retrieved. It should be noted that examples of the disclosed technology are described in the context of 5G network identifiers and components operating based on the 5G network identifiers. However, the disclosed technology is not limited to 5G systems. The disclosed technology may be used or implemented in other systems, networks, or environments where the translation of identifiers or information and the discovery of corresponding data repositories occurs.

A mobile network can be thought of as comprising two component networks, the radio access network (RAN) and the core network. For wireless networks operating in accordance with the 5G standard, these components are a 5G access network (5G-AN) and a 5G core network (5GC). For wireless networks operating in accordance with the 4G/LTE standard, these components include a RAN (like a 5G system) and an Evolved Packet Core Network (EPC). The 5GC may include various virtualized network functions (NFs), including, for example, an Access and Mobility Management Function (AMF) in communication with a Unified Data Manager (UDM). The AMF may be configured to handle connection and mobility management tasks. The UDM may be configured to manage user authentication, authorization, and device registration on the 5GC. The EPC may include its own NFs, including, for example, a Mobility Management Entity (MME) in communication with a Home Subscriber Server (HSS). The MME provides connection management functionality between UEs and the EPC. NFs may be implemented as one or more network devices or apparatuses.

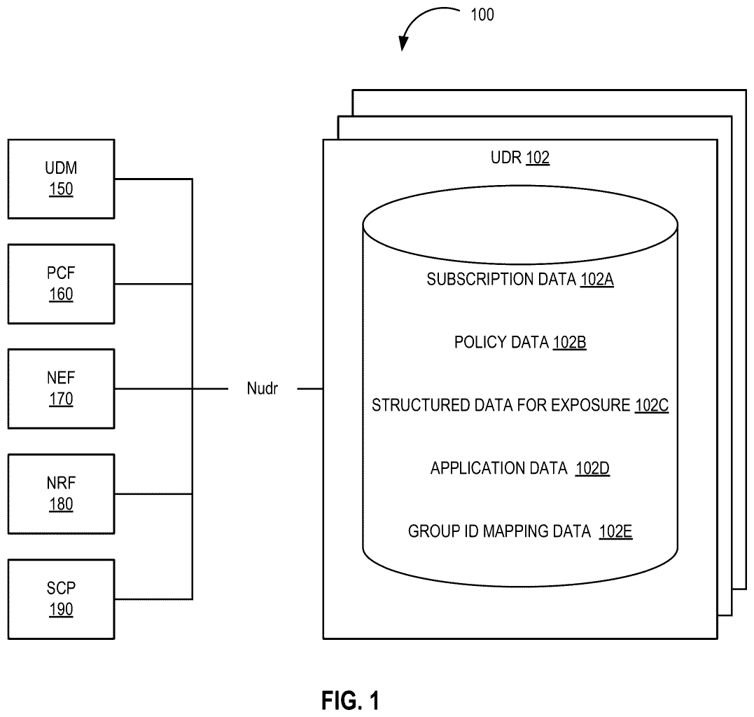

FIG. 1 illustrates an example data storage architecture 100 within which examples of the disclosed technology may be implemented. As illustrated in FIG. 1, data storage architecture 100 may include one or more User Data Repositories (UDRs) 102. As alluded to above, UDRs can refer to repositories for storing data grouped into different sets of information that may be accessed by various network services. These network services, referred to as NFs, may have defined functionalities such as authentication, policy control, and session management. The different types of information stored within the UDR may correspond to such functionalities and may include subscription data, authentication data, application data, and policy data. In the example data storage architecture 100, UDR(s) 102 may store subscription data 102A, policy data 1028, structured data for exposure 102C, application data 102D, and Group ID mapping data 102E. It should be noted that the types of stored data in UDR 102(s) are examples, and not intended to be limiting in any way. UDR(s) 102 may store, as well as receive, subscription data 102A, policy data 102B, structured data for exposure 102C, application data 102D, and Group ID mapping data 102E. Moreover, UDR(s) 102 may support subscriptions (of NFs. for example,) to notifications, where UDR(s) 102 may notify an NF subscriber of changes to data to which it is subscribed.

A Nudr interface may be leveraged by NFs to communicate with UDR(s) 102, e.g., access a particular set of data stored in UDR(s) 102. Some NFs that may send service requests to access data stored in UDR(s) 102, may include, but are not limited to the UDM 150, the Policy Control Function (PCF) 160, the Network Exposure Function (NEF) 170, the NF Repository Function (NRF) 180, and the Service Communication Proxy (SCP) 190.

A UDM, such as UDM 150 has been described above.

PCF 160 can manage and enforce policies related to quality of service (QOS), traffic management and resource allocation, and acts as a policy decision point in a 5G network. For example, PCF 160 can retrieve subscription information, including service entitlements, preferences, and QoS requirements from UDM 150. Such information serves as the basis for determining appropriate policy rules that are to be applied to a user's session/connection. The PCF may then communicate such policy rules to various control plane functions to ensure their enforcement.

NEF 170 may utilize UDM 150 to control user data exposure to external NFs. That is, NEF 170 may support the exposure of NF's capabilities in a 5G network to external NFs, such as third party application functions. External exposure can refer to monitoring capability, provisioning capability, policy/charging capability, and analytics reporting capability. For example, monitoring capability can refer to monitoring for a specific event for a UE in a 5G network, and making such monitoring events information available for external exposure via NEF 170.

NRF 180 can be used for service discovery of NFs. That is, NRF 180 can allow NFs to discover the service list offered by other NFs.

SCP 190 can function to forward messages and route messages to a destination NF or NF service, and to forward/route messages to a next hop SCP. Moreover, SCP 190 supports indirect communication whereby an NF service consumer may communicate with a target NF service producer via SCP 190. For example, the NF service consumer may perform discovery of the target NF service producer directly, or indirectly by delegating discovery of the target NF service producer to SCP 190. SCP 190 may use parameters provided by the NF service consumer to perform such discovery or selection of the target NF service producer.

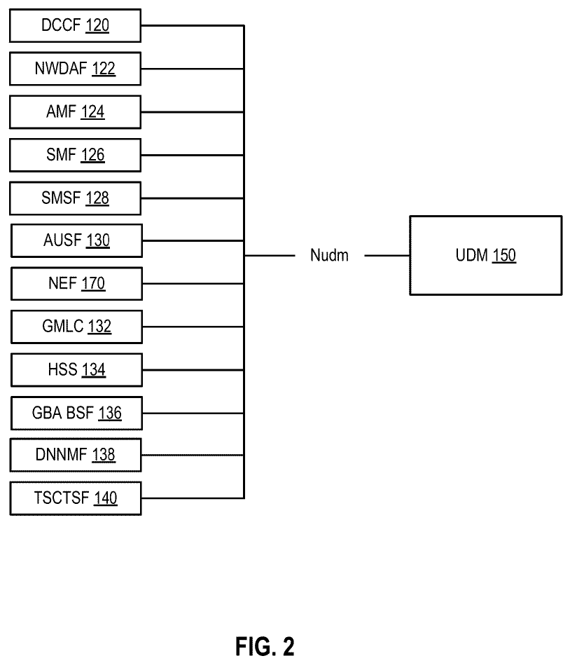

FIG. 2 illustrates interactions between UDM 150 and various network components or NFs that may transmit service requests or queries to UDM 150, which may ultimately access one or more UDR instances, an example of which is UDR 102 of FIG. 1. A Nudm interface, i.e., a service-based interface is used for such interactions with UDM 150.

As illustrated in FIG. 2, a Data Collection Configuration Function (DCCF) 120 may interact with UDM 150 to configure how user data is collected for various services. Network Data Analytics Function (NWDAF) 122 may exchange analytics data with UDM 150 to optimize network performance and the user experience. AMF 124 may coordinate with UDM 150 for authentication purposes, and to maintain user profiles for mobility management operations. Session Management Function (SMF) 126 works with UDM 150 to manage sessions and user data related to connectivity and service access. Short Message Service Function (SMSF) 128 may rely on UDM 150 to store/retrieve SMS-related user data. Authentication Server Function (AUSF) 130 may verify user credentials with UDM 150 during the authentication process.

NEF 170, as described above, utilizes UDM 150 to control user data exposure to external NFs. Gateway Mobile Location Center (GMLC) 132 may access location-related user data from UDM 150 for services that may need location information. Home Subscriber Server (HSS) 134 refers to a legacy function from 4G/LTE that interacts with UDM 150 to manage subscriber data in the transition to 5G. Generic Bootstrapping Architecture's Bootstrapping Server Function (GBA BSF) 136 uses UDM 150 for effectuating secure user data exchange during bootstrapping procedures. Dynamic Network Node Management Function (DNNMF) 138 can refer to a potentially custom or proprietary function that interacts with UDM 150 for dynamic network management and configuration.

Time Sensitive Communication and Time Synchronization Function (TSCTSF) 140 may provide direct services to an Application Function (AF) or indirect services via the NEF, e.g., NEF 170, using various application programming interfaces (APIs). Such services may include, e.g., exposing the AF with 5G synchronization capability/availability for providing time sensitive services, enabling the AF to provide the 5G network with an appropriate QoE requirement, etc. TSCTSF 140 may further perform control plane mapping between internal 5G system internal functions and a Deterministic Networking (DetNet) controller (not shown).

When such services or NFs request access to data stored in a UDR instance, the services/NFs may include a network identifier, such as a GPSI value or a SUPI value. For example, an NF service consumer, such as NEF 170, may transmit a request to UDM 150, e.g., in the form of a GET request, that contains a UE's identity (ueId) along with regarding information the type of requested information/data/resources associated with the ueId. In the event that the GET request contains a type 2 ueId, such as a GPSI value, requesting the UDM to retrieve the SUPI and SUPI value-identified data or subscriber resources, issues can arise. It should be noted that typically, SUPI values are the preferred internal ID used in communications networks, as compared to GPSI values, which are typically used to identify subscribers external to the communications network. Thus, to identify the correct subscription data upon receipt of an external (to the network) ID (GPSI value), the external ID is translated into an (internal) network ID (SUPI value). UDR partitioning for SUPI values/ranges can be attributed to SUPI values being used for routing purposes, and for identifying, e.g., an NF serving a given SUPI value/range, and why typically, a lookup UDR is configured (to find the appropriate service producer).

When a request specifies a GPSI value necessitating translation to a SUPI value, UDM 150 can leverage a 5G specified identifier translation mechanism. That is, UDM 150 is able to translate the received GPSI value to a SUPI value. UDMs may be stateful or stateless. When a UDM is stateful, the UDM is configured to itself, store data locally. When a UDM is stateless, the UDM stores data externally, such as the case with the example storage data architecture 100, where UDM 150 maintains user/subscription data in one or more UDRs, such as UDR 102. Accordingly, and while UDM 150 would be able to return the SUPI value corresponding to the GPSI value received in the request, UDM 150 would still have to access one or more UDRs to retrieve the requested data or resources associated with the SUPI value. For example, requests regarding event exposure procedures may often only contain a GPSI value, and discovery should be performed to identify the correct SUPI-based UDR partition based on the SUPI value corresponding to where the UE data is provisioned.

However, despite the ability to identify a corresponding SUPI value, UDM 150, per its conventional operation would still transmit the request to the UDR in which the identity data corresponding to the GPSI value is stored. For example, a first UDR instance of UDR(s) 102 referred to as a lookup UDR instance stores only identity data (hence the aforementioned ability to determine a SUPI value corresponding to a GPSI value. Thus, the request for data or resources would ultimately go un-serviced because the request would not be sent to the appropriate UDR instance, i.e., a second UDR instance of UDR(s) 102 which stores the requested data or resources corresponding to the translated SUPI value. Instead, UDM 150 would still send the service request to the first/lookup UDR instance of UDR(s) 102, and the first/lookup UDR instance would respond to UDM 150 with a failure or error status code, which would then be forwarded to the requesting NF service consumer.

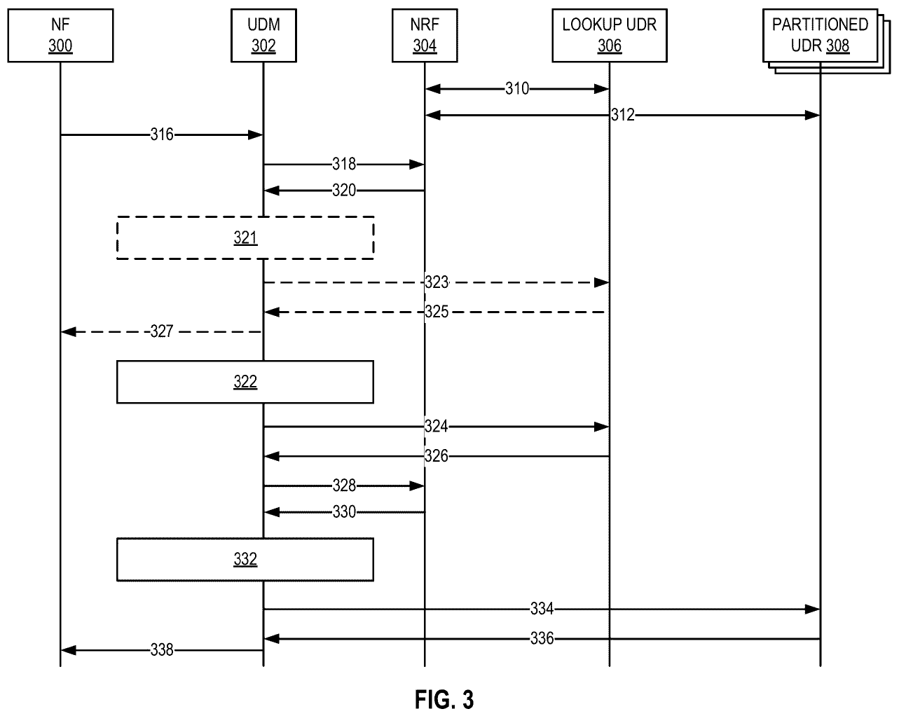

For example, referring now to FIG. 3, a first UDR instance, i.e., lookup UDR instance 306 may perform a NFRegister operation 310 with NRF 304. Typically, NRFs, such as NRF 304, comprise or include a NFManagement service that allows a UDR instance to register, update, or deregister its profile in the NRF. In this example, lookup UDR 306, as explained above, stores GPSI value-based identity data. Thus, NFRegister operation 310 would specify to NRF 304 that lookup UDR instance 306's profile is that of a UDR instance storing ueId ranges of ueId types other than type 1 ueIds/SUPIs. Partitioned UDR instances 308 would also perform NFRegister operations 312 with NRF 304 to register partitioned UDR instances 308 profiles as storing various ranges of type 1 ueIds. As noted above, SUPI values can be partitioned amongst a plurality of UDR instances, each of the plurality of UDR instances storing a particular range of SUPI values.

When NF 300, e.g,. the AMF or NEF, transmits a service request 316 to UDM 302, where UDM 302 is a stateless UDM, service request 316 may specify a type 2 ueId/GPSI value comprising, e.g., a MSISDN or external ID. UDM 302 may then interact with NRF 304 by performing a NF Discover operation 318 to discover UDR profiles of UDR instances with which UDM 302 can communicate. The UDR profiles would include the profiles of lookup UDR instance 306 and those of partitioned UDR instances 308. NRF 304 returns a HTTP 200 OK status code along with the UDR profiles at operation 320.

Conventionally, at operation 321, UDM 302 upon receiving the UDR instance profiles returned by NRF 304, would select the UDR instance profile corresponding to the type 2 ueId/GPSI value received by UDM 302 in service request 316. Because UDM 302 uses the type 2 ueId/GPSI value to select the UDR instance profile, lookup UDR instance 306 will be selected by UDM 302 as the UDR instance to which service request 316 will be forwarded per Nudr service request 323. UDR instance 306 is registered with the GPSI value range which makes it a qualified endpoint to fetch the identity data. Accordingly, lookup UDR instance 306 transmits a failure or error message 325, e.g., a 4xx or 5xx HTTP status code, back to UDM 302. UDM 302 then transmits or forwards that failure or error message 325 as failure or error message 327 to NF 300.

Like the above-described conventional UDM operation, at operation 322, UDM 302 may still use the type 2 ueId/GPSI value received by UDM 302 in service request 316 to select the appropriate UDR instance, in this example, lookup UDR instance 306. However, and in contrast to conventional UDM operation, UDM 302 transmits a GET operation or method 324 that specifies the type 2 ueId/GPSI value, along with the Uniform Resource Identifier (URI) resource being accessed, in this case, the IdentityData resource specified in the 5G standard. This GET method or operation 324 requests that lookup UDR instance 306 identify a type 1 ueId/SUPI value corresponding to the type 2 ueId/GPSI value specified in service request 316. In other words, UDM 302 translates the type 2 ueId/GPSI value to a type 1 ueId/SUPI value. Accordingly, lookup UDR instance 306 returns a HTTP 200 OK status code along with the corresponding type 1 ueId/SUPI value to UDM 302 at operation 326.

UDM 302 may then perform another NF Discover operation, e.g., NF Discover operation 328. However, UDM 302 specifies the type 1 ueId/SUPI value translated from the type 2 ueId/GPSI value in NF Discover operation 328 rather than the type 2 ueId/GPSI value received in service request 316. Similar to operation 320, NRF 304 returns an HTTP 200 OK status code along with the UDR profiles corresponding to lookup UDR instance 306 and partitioned UDR instances 308 at operation 330.

At operation 332, UDM 302 may then select an appropriate UDR instance corresponding to one of the UDR profiles registered as storing a range of type 1 ueId/SPUI values that includes the translated type 1 ueId/SUPI value. In this example, the appropriate UDR instance will be one of the partitioned UDR instances 308. Thus, in accordance with examples of the disclosed technology, and unlike the conventional operation of UDM 302 described above, UDM 302 will not transmit or forward service request 316 to lookup UDR instance 306 resulting in an error. Instead, due to translating the type 2 ueId/GPSI value to a type 1 ueID/SUPI value, any requested data/resources stored by a partitioned UDR instance 308 can be identified and returned to satisfy service request 316. That is, UDM 302 may transmit a Nudr-dr service request 334, relaying service request 316 to the appropriate one of partitioned UDR instances 308. Because the appropriate one of partitioned UDR instances 308 is able to identify/retrieve data/resources corresponding to service request 316/334, that partitioned UDR instance can return a HTTP 200 OK status code along with the requested data. UDM 302 may forward the HTTP 200 OK status code/requested data to NF 300 at operation 338.

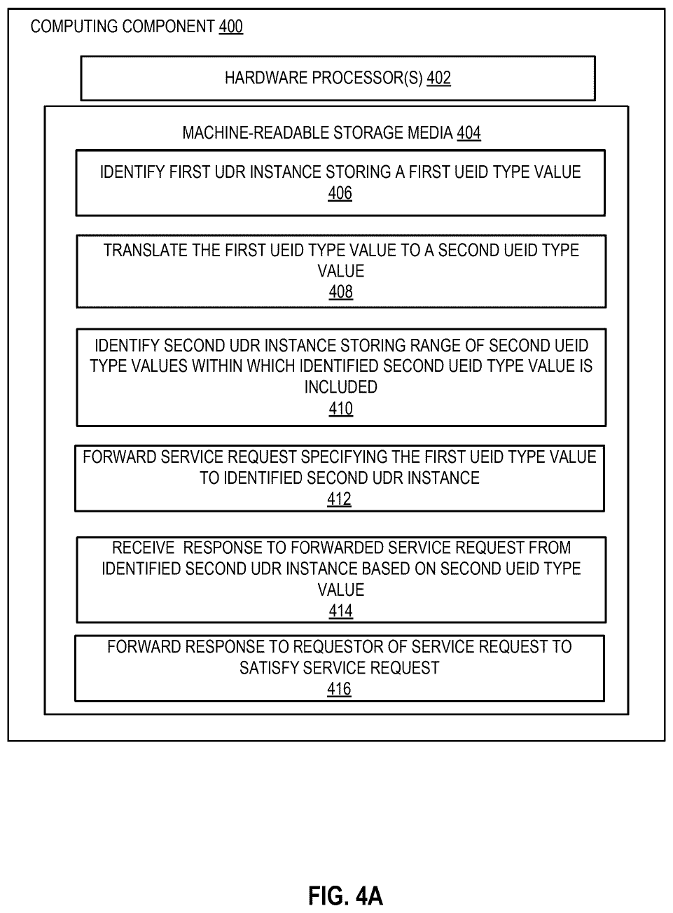

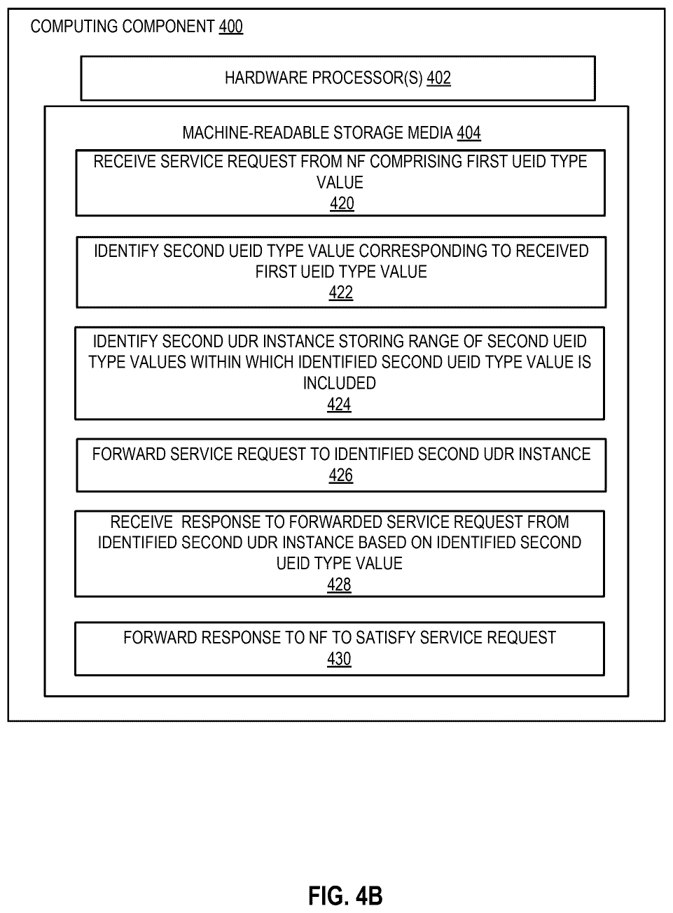

FIG. 4A illustrates a computing component that may be used to execute instructions to achieve UDM functionality for translating network identifiers and identifying a UDR instance in accordance with examples of the disclosed technology. Referring now to FIG. 4a, computing component 400 may be, for example, a server computer, a controller, or any other similar computing component capable of processing data. In the example implementation of FIG. 4A, computing component 400 includes a hardware processor 402, and machine-readable storage media 404.

Hardware processor 402 may be one or more central processing units (CPUs), semiconductor-based microprocessors, and/or other hardware devices suitable for retrieval and execution of instructions stored in machine-readable storage media 404. Hardware processor 402 may fetch, decode, and execute instructions, such as instructions 406-418. As an alternative or in addition to retrieving and executing instructions, hardware processor 402 may include one or more electronic circuits that include electronic components for performing the functionality of one or more instructions, such as a field programmable gate array (FPGA), application specific integrated circuit (ASIC), or other electronic circuits.

Machine-readable storage media, such as machine-readable storage media 404, may be any electronic, magnetic, optical, or other physical storage device that contains or stores executable instructions. Thus, machine-readable storage media 404 may be, for example, Random Access Memory (RAM), non-volatile RAM (NVRAM), an Electrically Erasable Programmable Read-Only Memory (EEPROM), a storage device, an optical disc, and the like. In some examples, machine-readable storage media 404 may be a non-transitory storage medium, where the term “non-transitory” does not encompass transitory propagating signals. As described in detail below, machine-readable storage media 404 may be encoded with executable instructions, for example, instructions 406-418.

Hardware processor 402 may execute instruction 406 to receive a service request from a NF comprising a first ueId type value. As described above, the UDM of a 5G core network may interact with various services or NFs. Depending on the service or NF, the service request may specify either a type 1 ueId/SUPI value or a type 2 ueId/GPSI value. In the event, the UDM receives a service request already specifying type 1 ueId/SUPI value, the UDM can perform NF discovery (as described above) with the NRF to obtain UDR profiles associated with UDR instances storing data/resources associated with type 1 ueId/SUPI value ranges.

Hardware processor 402 may then execute instruction 406 to identify a first UDR instance storing a first ueId type value. In some scenarios, the first ueId type value may be specified in a service request received from a NF. As described above, the UDM of a 5G core network may interact with various services or NFs. Depending on the service or NF, the service request may specify either a type 1 ueId/SUPI value or a type 2 ueId/GPSI value. In the event, the UDM receives a service request already specifying type 1 ueId/SUPI value, the UDM can perform NF discovery (as described above) with the NRF to obtain UDR profiles associated with UDR instances storing data/resources associated with type 1 ueId/SUPI value ranges. An appropriate URD instance can be identified and selected, and the service request can be satisfied.

In the event that the service request comprises a type 2 ueId/GPSI value, hardware processor 402 may again, execute instruction 406 to identify a first UDR instance storing the first ueId type value of a plurality of first ueId type values. However, in this case, the first ueId type value may be a GPSI value. Thus, when the UDM performs a NF discovery operation to obtain UDR profiles from the NRF, the UDM uses the first ueId type/GPSI value, the NRF will return UDR instance profiles, and the UDM can select the lookup UDR instance storing the first ueId type/GPSI values.

Hardware processor 402 may execute instruction 408 to translate the first ueId type value to a second ueId type value based on identity data stored in the first UDR instance. In some examples, as described above, the UDM may use a GET operation specifying the first ueId type/GPSI value and requesting an IdentityData resource to identify the second ueId type/SUPI value corresponding to the first ueId type/GPSI value.

Hardware processor 402 may execute instruction 410 to identify a second UDR instance storing a range of second ueId type values within which the identified second ueId type value is included. Again, an entity, such as a telecommunications operator may have a large number of subscribers such that its UDR is partitioned into a plurality of UDR instances, each of the plurality of UDR instances storing a particular range of second ueId type/SUPI values. Accordingly, because the first ueId type/GPSI value has been translated into the second ueId type/SUPI value, the UDM is able to perform another discovery operation using the second ueId type/SUPI value, receive the appropriate UDR instance profiles, and select the appropriate UDR instance based on the UDR instance profile matching or corresponding to the second ueId type/SUPI value.

In this way, hardware processor 402 is able to execute instruction 412 to forward a service request specifying the first ueId type value to the identified second UDR instance, i.e., one of the partitioned UDR instances storing second ueId type/SUPI values and corresponding user/subscriber data. Accordingly, the service request can be satisfied (recalling that conventionally, the UDM would forward the service request to the first ueId type/lookup UDR instance which only stores identity data).

Hardware processor 402 may execute instruction 414 to receive a response to the forwarded service request from the second UDR instance based on the identified second ueId type value. As noted above, because the UDM is able to select the appropriate UDR instance (based on the second ueId type/SUPI value), the service request can be satisfied.

Thus, hardware processor 402 may execute instruction 416 to forward the response to a requestor of the service request to satisfy the service request. Following the above example scenario, the requestor of the service request may be a NF. The response can be a HTTP 200 OK (success) status code sent in conjunction with the requested data to the NF that sent the service request to the UDM.

FIG. 4B illustrates a computing component that may be used to execute instructions to achieve UDM functionality to identify a UDR instance in accordance with examples of the disclosed technology. Referring now to FIG. 4B, as already described above with respect to FIG. 4A, computing component 400 may comprise hardware processor 402 and machine-readable storage media 404. Machine-readable storage media 404 may be encoded with executable instructions, for example, instructions 420-430.

Similar to instruction 406 of FIG. 4A, hardware processor 402 may execute instruction 420 to receive a service request from a NF comprising a first ueId type value. As described above, the UDM of a 5G core network may interact with various services or NFs. Depending on the service or NF, the service request may specify either a type 1 ueId/SUPI value or a type 2 ueId/GPSI value.

To the above, and depending on the type of ueId that is specified in the service request, hardware processor 402 may execute instruction 422 to identify a second ueId type value corresponding to the received first ueId type value. As described above, the 5G standard specifies an IdentityData resource that can be leveraged in accordance with the disclosed technology to translate between ueId types when warranted (depending on the ueId type specified in a received service request. However, in some scenarios, examples of the disclosed technology need not necessarily involve translating between ueId types. For example, the UDM (or other component) may access a lookup table (or perform some other determination) that identifies a second ueId type value that corresponds to the received first ueId type value.

Similar to hardware processor executing instruction 412 (FIG. 4A), hardware processor 402 may execute instruction 424 to identify a second UDR instance storing a range of second ueId type values within which the identified second ueId type value is included. Again, because a corresponding second ueId type value can be identified based on the first ueId type value, which can be a GPSI, the UDM is able to perform another discovery operation using the second ueId type/SUPI value, receive the appropriate UDR instance profiles, and select the appropriate UDR instance based on the UDR instance profile matching or corresponding to the second ueId type/SUPI value.

In this way, similar to executing instruction 414 (FIG. 4A), hardware processor 402 is able to execute instruction 426 to forward the service request to the identified second UDR instance, i.e., one of the partitioned UDR instances storing second ueId type/SUPI values and corresponding user/subscriber data.

Similar to executing instruction 416, processor 402 may execute instruction 428 to receive a response to the forwarded service request from the identified second UDR instance based on the identified second ueId type value.

Similar to executing instruction 418, hardware processor 402 may execute instruction 430 to forward the response to the NF to satisfy the service request. Again, the response can be a HTTP 200 OK (success) status code along with the requested data to the NF that sent the service request to the UDM.

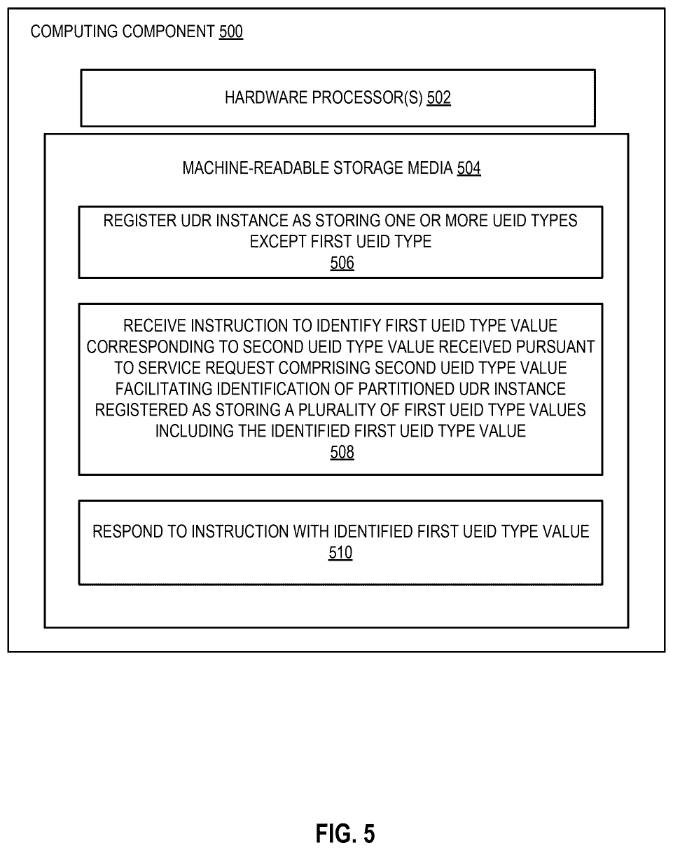

FIG. 5 illustrates a computing component that may execute instructions to achieve UDR functionality to respond to and satisfy a service request based on an identified network identifier in accordance with examples of the disclosed technology. Referring now to FIG. 45, as already described above with respect to FIGS. 4A and 4B, a computing component 500 (similar to computing component 400) may comprise a hardware processor 502 (similar to hardware processor 402) and machine-readable storage media 504 (similar to machine-readable storage media 404). Machine-readable storage media 504 may be encoded with instructions 506-510.

Hardware processor may execute instruction 506 to register a UDR instance as storing one or more ueId types except for a first ueId type. As discussed above, a stateless UDM uses a UDR or a plurality of UDR instances to store user/subscription data (or other data of interest in other contexts or applications). Thus, UDR instances may register with the NRF of a network such that each of the UDR instances has a URD profile that characterizes the UDR instances based on the type(s) of ueId values that are stored therein. In this way, a UDM will be able to determine or discover an appropriate UDR instance to access to satisfy a service request.

Hardware processor 502 may execute instruction 508 to receive an instruction to identify a first ueId type value corresponding to a second ueId type value received pursuant to a service request comprising the second ueId type value, which in turn facilitates identification of a partitioned UDR instance registered as storing a plurality of first ueId type values including the identified first ueId type value. As described above, the UDM may translate between ueId types. In this scenario, the UDM may translate the second ueId type value (e.g., a GPSI value) into a first ueId type value (e.g., a SUPI value).

Regardless, once the first ueId type value is identified, hardware processor 502 may execute instruction 510 to respond to the instruction with the identified first ueId type value. In some examples, hardware processor 502 may effectuate the response by transmitting an HTTP success status code (e.g.,.200 OK status code) to the UDM. Once the UDM has the first ueId type value, i.e., a SUPI value, the UDM may proceed with forwarding the service request to a partitioned UDR instance storing user/subscription data or records corresponding to the first ueId/SUPI value. Thus, the service request can be satisfied/serviced appropriately.

As described herein, examples of the disclosed technology avoid issues with conventional UDM operations that in some scenarios, may not be able to return/provide access to an appropriate UDR instance depending on the type of ueId specified in the service request. Some systems or methods may attempt to address the translation contemplated herein, but force an NF service consumer to translate between ueId types so that the service request will already specify, e.g., the type 1 ueId/SUPI value. However, this can result in undesirable latency and can negatively impact the user experience. That is, the functionality of the UDM/UDR deployment is transparent to the NF service consumers, and network identifier translation traffic to the UDM is reduced/negated altogether because the UDM/NRF/UDR attend to translating between ueId types. Moreover, the issues arising from a stateless UDM interacting with non-partitionable UDR instances storing only identity data, and partitioned UDR instances storing subscriber data/resources in association with SUPI values, are negated because of the ueId type translation and the ability to perform UDR instance discovery using the translated ueId type.

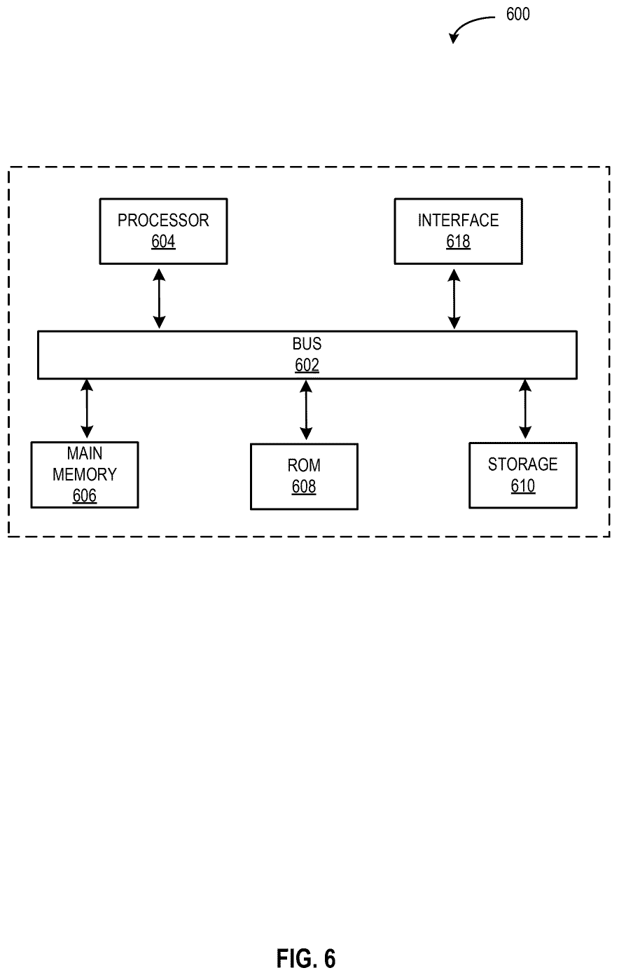

FIG. 6 depicts a block diagram of an example computer system 600 in which various examples of the disclosed technology described herein may be implemented. The computer system 600 includes a bus 602 or other communication mechanism for communicating information, one or more hardware processors 604 coupled with bus 602 for processing information. Hardware processor(s) 604 may be, for example, one or more general purpose microprocessors.

The computer system 600 also includes a main memory 606, such as a random access memory (RAM), cache and/or other dynamic storage devices, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions.

The computer system 600 further includes a read only memory (ROM) 608 or other static storage device coupled to bus 602 for storing static information and instructions for processor 604. A storage device 610, such as a magnetic disk, optical disk, or USB thumb drive (Flash drive), etc., is provided and coupled to bus 602 for storing information and instructions.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 600 may implement the techniques described herein using customized hard-wired logic, one or more ASICs or FPGAs, firmware and/or program logic which in combination with the computer system causes or programs computer system 600 to be a special-purpose machine. According to one example of the disclosed technology, the techniques herein are performed by computer system 600 in response to processor(s) 604 executing one or more sequences of one or more instructions contained in main memory 606. Such instructions may be read into main memory 606 from another storage medium, such as storage device 610. Execution of the sequences of instructions contained in main memory 606 causes processor(s) 604 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 610. Volatile media includes dynamic memory, such as main memory 606. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same. Non-transitory media is distinct from but may be used in conjunction with transmission media.

The computer system 600 also includes a communication interface 618 coupled to bus 602. Network interface 618 provides a two-way data communication coupling to one or more network links that are connected to one or more local networks. For example, communication interface 618 may be an integrated services digital network (ISDN) card, cable modem, satellite modem, or a modem to provide a data communication connection to a corresponding type of telephone line. As another example, network interface 618 may be a local area network (LAN) card to provide a data communication connection to a compatible LAN (or WAN component to communicate with a WAN). Wireless links may also be implemented. In any such implementation, network interface 618 sends and receives electrical, electromagnetic or optical signals that carry digital data streams representing various types of information.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A computer-implemented method, comprising:
identifying a first Unified Data Repository (UDR) instance storing a first user equipment identifier (UEID) type value;
translating the first UEID type value to a second UEID type value;
identifying a second UDR instance storing a range of second UEID type values within which the identified second UEID type value is included;
forwarding a service request specifying the first UEID type value to the identified second UDR instance;
receiving a response to the forwarded service request from the identified second UDR instance based on the second UEID type value; and
forwarding the response to a requestor of the service request to satisfy the service request.

2. The computer-implemented method of claim 1, wherein the requestor of the service request comprises a network function (NF)

3. The computer-implemented method of claim 1, wherein the second UDR instance comprises one of a plurality of UDR instances storing other ranges of second UEID type values.

4. The computer-implemented method of claim 1, wherein identifying the first UDR instance comprises performing an NF discover process with a NF Repository Function (NRF) with which the first UDR instance is registered.

5. The computer-implemented method of claim 1, wherein the first UEID type comprises a Generic Public Subscription Identifier (GPSI).

6. The computer-implemented method of claim 1, wherein the second UEID type comprises a Subscription Permanent Identifier (SUPI).

7. The computer-implemented method of claim 1, wherein the translating comprises requesting identity data stored by the first UDR instance specifying the second UEID type value corresponding to the first UEID type value.

8. The computer-implemented method of claim 7, wherein the identifying of the second UDR instance comprises performing an additional NF discovery process with the NRF using the second UEID type value.

9. The computer-implemented method of claim 8, further comprising, in response to performing the additional NF discovery process, receiving a plurality of UDR profiles corresponding to the range of second UEID type values including the second UEID type value.

10. The computer-implemented method of claim 1, further comprising, selecting the identified second UDR instance corresponding to the second UEID type value.

11. A computer-implemented method, comprising:
receiving a service request from a network function (NF) comprising a first user equipment identifier (UEID) value;
identifying a second UEID type value corresponding to the received first UEID value;
identifying a second UDR instance storing a range of second UEID type values within which the identified second UEID type value is included;
forwarding the service request to the identified second UDR instance;
receiving a response to the forwarded service request from the identified second UDR instance based on the identified second UEID type value; and
forwarding the response to the NF to satisfy the service request.

12. The computer-implemented method of claim 11, wherein the second UDR instance comprises one of a plurality of UDR instances storing other ranges of second UEID type values.

13. The computer-implemented method of claim 11, wherein the first UEID type comprises a Generic Public Subscription Identifier (GPSI).

14. The computer-implemented method of claim 11, wherein the second UEID type comprises a Subscription Permanent Identifier (SUPI).

15. The computer-implemented method of claim 11, wherein the identifying of the second UEID type value comprises receiving a request for identity data specifying the second UEID type value corresponding to the first UEID type value.

16. The computer-implemented method of claim 15, further comprising responding to the received request with a hypertext transfer protocol (HTTP) success status code including the second UEID type value.

17. A computer-implemented method, comprising:
registering a unified data repository (UDR) instance as storing one or more user equipment identifier (UEID) types except a first UEID type;
receiving an instruction to identify a first UEID type value corresponding to a second UEID type value received as part of a service request comprising the second UEID type value facilitating identification of a partitioned UDR instance registered as storing a plurality of first UEID type values including the identified first UEID type value; and
responding to the instruction with the identified first UEID type value.

18. The computer-implemented method of claim 17, wherein the service request is received from a network function (NF).

19. The computer-implemented method of claim 17, wherein the second UEID type comprises a Generic Public Subscription Identifier (GPSI).

20. The computer-implemented method of claim 17, wherein the first UEID type comprises a Subscription Permanent Identifier (SUPI).
